(19) United States
(12) Patent Application Publication
(10) Pub. No.: US 2014/0172661 A1
(43) Pub. Date: Jun. 19, 2014

(54) Method Enabling Member Financing of Media Productions

(71) Applicant: Robin Ross Cooper, La Mesa, CA (US)

(72) Inventor: Robin Ross Cooper, La Mesa, CA (US)

(21) Appl. No.: 14/106,451

(22) Filed: Dec. 13, 2013

Related U.S. Application Data
(60) Provisional application No. 61/737,806, filed on Dec. 16, 2012.
(60) Provisional application No. 61/836,334, filed on Jun. 18, 2013.
(60) Provisional application No. 61/866,979, filed on Aug. 16, 2013.

(51) Int. Cl. G06Q 40/06

(52) U.S. Cl. CPC G06Q 40/06
USPC 705/35

(57) ABSTRACT

A system for financing of film and media productions of individual movies or slates of movies which provides non-monetary enhancements to return on investment for subscribing members who may be television and media broadcasters such as cable systems and satellite broadcasters. The system enhanced return on investment such as earlier broadcast rights and advertisement availments for subscribing members as well as monetary return from revenues.

### FIELD OF THE INVENTION

This application claims priority to U.S. patent application Ser. No. 61/737,806 filed on Dec. 13, 2012, and U.S. Ser. No. 61/836,334 filed on Jun. 18, 2013, and, U.S. patent application Ser. No. 61/866,979 filed on Aug. 16, 2013, each of which is respectively included herewith in its entirety by this reference thereto.

The present invention relates to movie and media production and financing through the formation of investor-financed studios. More particularly, the disclosed method and system herein relates to a business method employing a corporation with stockholders or a membership organization, either of which employs investor funding for film and media production and/or the provision of financing for motion picture and television and media productions.

### BACKGROUND OF THE INVENTION

The modern film industry produces blockbuster films as well as unsuccessful films and many which lie somewhere in between. Some films may be produced and paid for by large Hollywood studios and there are a good number of independent film producers which are outside of that which is Hollywood. One element, which is a common factor with mega-studios as well as large and small independent film producers, is the need for financing of the film production. Production of films and television and other media is extremely expensive and since no revenue, if any, is realized until the film is distributed and viewers view it, funding for such movie and broadcast predations can be for months or years while the film is being made.

There are a few common modes for modern film producers to achieve sufficient funding to produce what is generally a very expensive media or film product. Equity financing is one mode of achieving funds. Essentially the film maker or production company gives up a percentage of ownership to investors who expect a return on their investment. While the potential for a huge return exists for such investors should the film or production be a blockbuster, generally the opposite may be true and the investor is lucky to have a profit from their investment.

One means of attracting solo investors as well as banks and hedge funds looking for a return and used to risk, is slate financing. Essentially investors, such as wealthy individuals, hedge funds, and insurance company investment arms are offered an investment in a slate of proposed films or media projects projected for future production. Such institutional investors are generally willing to take the risk that only one or two of the entire slate will make a reasonable profit. Such a slate fund may even be formed which offers differing types of investment based on differing types of risk and security for the differing investors.

This slate style funding approach has resulted in hedge funds and film funds which are put together to allow differing investors to finance films. Essentially, differing funds will seek investors to finance films and/or more likely, slates of films of specific genres and with different producers, which may have proven successful in the past from an investment point of view when their films or projects made a profit.

Additionally, film producers may advance-sell the distribution rights for home video, pay TV, and free TV to various entities in contracts for future payment for such rights. However, this can discount the amount they might receive in the event the movie or production is a huge hit. With such signed contracts in hand indicating the presence of future revenue for the un-produced film or production, the producer uses the value of these contracts, which as noted may be diminished due to having to make advance deals for such as collateral against a production loan or bank guarantee.

However, whether it be slate fund investors or the selling of rights for broadcast and theater release in advance, the funds advanced the production company can be diminished in value as the investment funds and institutional investors are only interested in a substantial profit on their investment and thus the production company pays substantial interest and loan fees. Further, since selling the theater and broadcast rights in advance will yield only a contact for a run-of-the-mill type film, rather than what could have been sold for a blockbuster production, this type of financing yields lower income to the production company. Still further, the free and subscription broadcasters such as cable and satellite broadcasters, other than a slight discount, generally gain no other market advantage by purchasing broadcast rights in advance, nor any share of the income or additional profit, and still must wait for the theater debut and sales of DVD versions of the production to finish, to have the rights purchased to air it.

As such, their exists an unmet need, for a method and system for financing the production of movie and theatrical endeavors which will allow the production company a more reasonable return on their investment of time and borrowed funds, than is conventionally available using hedge funds and institutional investors. Such a system should endeavor to operate more as a membership system, allowing the production company and the member broadcasters, to gain both a market advantage as well as a return on investment traditionally taken by the hedge funds and institutional investors. Such a system should provide the advantage of financing made-for-broadcaster movies and productions, by stockholder or member broadcasters and allow stockholder or member broadcasters greater input as to the media provided them as well as income from the movies and other productions made for them. Still further, such a system should work to the advantage of the parties performing the most work and distribution of the films and media, thereby allowing the production company to sell broadcast rights in a fashion which allows the production company and the broadcasters to both reap the rewards of a huge hit movie or media production. Such rewards should come while concurrently not diminishing the initial funds invested with the production company with the assumption of a less than stellar movie. Finally, such a method and system should endeavor to provide some or all of the profits reaped by hedge funds and institutional investors, into the hands of the production company and the broadcasters, through the provision of new and additional revenue sources for the broadcasters, as a more reasonable return for their investment in facilities, infrastructure, and distribution.

In this respect, before explaining at least one embodiment of the herein disclosed membership based method and system for production financing, it is to be understood that the system and method herein is not limited in its application to the details and to the arrangement of the steps set forth in the previous description or illustrated in the drawings nor the steps outlined in the specification. The disclosed financing system is capable of other embodiments and of being practiced and carried out in various ways as those skilled in the art will readily ascertain once educated in the novel device and method of this application.

Also, it is to be understood that the phraseology and terminology employed herein are for the purpose of description and should not be regarded as limiting in any manner. As such, those skilled in the art will appreciate that the conception upon which this disclosure for movie and theatrical product financing is based, may readily be utilized as a basis for designing other methods and systems for carrying out the several purposes of the disclosed device herein. It is important, therefore, that the claims be regarded as including such equivalent construction insofar as they do not depart from the spirit and scope of the present invention.

### SUMMARY OF THE INVENTION

The systems and methods herein disclosed and described provide a solution to the noted shortcomings in prior art in conventional film, media, and theatrical production financing, through the provision of a system encouraging investment by stockholders or members who are also operators such as broadcasters, at the beginning of film and movie production, of one or a slate of films or theatrical productions.

By operating as a membership organization or a corporation with stockholders receiving investor benefits, where the subscribing members or stockholders are the broadcasters or television operators, who by becoming subscribing members and investing in the organization or corporation, operate to also position themselves as the original investors for chosen or offered movies, television, and other media produced by the production company.

In return for new revenue producing rights, and for other benefits for investors who are television operators or broadcasters, the capital required to actually produce such movies and television and media productions, will be supplied by the operators and broadcasters who in the end require it as product. Further, television operators or broadcasters worldwide have huge investments in infrastructure, telecommunications and broadcasting, and the system herein, with member broadcasters operating as a collective and banding together through the service provider, the smaller investments of such parties, can raise the aggregate huge sums traditionally only available from hedge funds and institutional investors such as insurance companies and investment funds.

In providing an investor service, allowing television operators or media broadcasters to band together to yield the financial strength heretofore only available from hedge funds and institutional investors, the system herein as provided by the system operator, places the system operators and broadcasters and the like, as investors and owners, in the position to make a profit on their initial investment in one or a slate of movies or media.

The system and provider will thereby be an important source of new and different revenues for the investor broadcasters and television operators which at present is limited to commercial revenue for broadcasters at the very tail end of the release cycle for films and media. The increased revenue from their investment and ownership in the system, will lower their cost of product, and thereby increase their profitability.

By increasing the profit potential and eventual profits of these investor television operators and broadcasters in the system, it will increase the value of shares of these broadcast and operator firms and encourage investment therein. Further, by showing another reliable source of profit and income, the investor broadcasters and system operators of the system herein are also enabled to achieve better borrowing terms for their own credit lines. The increased financing and decreased cost of borrowing combined with an increase in corporate value are all extra benefits to the system operator investors in the system operated by the system provider as herein disclosed, beyond the share of income from such media production traditionally going to banks and hedge funds.

There are estimated to be 20,000 or more television and cable operators and broadcasters world wide, and most are smaller concerns in the media world and much smaller than networks such as FOX, CBS, and NBC for example. Using the system herein, this large number of globally situated broadcasters can, in becoming investing members of the system provided and operated by the system provider, achieve additional benefits as financiers of the very media they will be selling. By taking advantage of their special privileges as investors to the system herein, and contributing investment capital to the system herein, the broadcaster and system operator members of the system herein, in addition to profits from ownership, can be provided the ability to have slates of movies and shows made, which are custom tailored to their broadcast audiences.

Heretofore, system operators and broadcasters such as television cable companies and over the air broadcast stations lacked sufficient capital individually to pay for and actually order a slate of films or shows which were from the start, well adapted to broadcast formats and broadcast audiences and schedules. Instead, broadcasters had to battle with each other for whatever movies, shows, and other broadcastable media were produced by production companies, which of course had been financed by banks and hedge funds. Worse yet, broadcasters, currently, are the last in line to receive rights to broadcast films and media which can be 4-6 years after release.

As investors or stockholders of the system herein as operated by the provider of the system, investor broadcaster members and television system operators, investing in the corporation or other entity of the system herein, can be given early release rights as a bonus to their investor status and investment and receive such right after theaters, in the first two years subsequent to release, when there is more public interest.

The system provider, by grouping the stockholder or member investment in the system, can provide members of this 20,000 strong group of system operators and broadcasters, such as cable companies and small television chains, internet television providers, and large hotel chains with in room video, and other concerns with broadcasting ability, the ability to actually work through the provider and directly with the production companies, to produce movies and media.

Further, as noted, such system operators and broadcasters instead of having to wait for the theaters and DVD publication of the media, and release as the last in line under the present system, can be given early release dates as bonuses to their investment in the system. Early release dates are a competitive advantage in attaching viewers during ratings weeks, where the advertising rates are set according to the number of viewers of broadcast stations. Such a bonus will encourage more investment in the system by broadcasters eager for such an advantage, enabling the system provider to finance film and media on behalf of the user members.

As such, the business method herein disclosed, by operating to pool the collective capital of investor system operators and broadcasters worldwide, can finance the movies and media which is the product sold and broadcast by such broadcasters, without the high cost of bank loans, hedge fund investments, and institutional investors, thus lowering the cost of production and stabilizing funds available to producers. The system will provide investor system operators and broadcasters with a new source of revenue, and decreased cost of product, as well as increased stock value over time and a more attractive balance sheet to lenders.

With respect to the above description, before explaining at least one preferred embodiment of the herein financing method and system in detail, it is again to be understood that the invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other business systems for grouping media broadcasters to finance the media broadcast and lower costs to increase profits. It is important, therefore, that the claims be regarded as including such equivalent construction and methodology insofar as they do not depart from the spirit and scope of the present invention.

It is an object of this invention to provide a system from a system provider which enables a pooling of funds from small and large TV system operators and broadcaster investors to thereby provide a means for capitalizing the financing of producers of media and movies broadcast by the broadcasters.

It is a further object of the invention to lower the cost of production to the investor broadcasters and system operators to the system, by providing a new source of revenue from movie and media production.

It is another object of the invention, to involve the TV system operators and broadcasters worldwide in the financing of movies and media to yield a stable pool of funds and cash flow for the operator of the system to finance production companies for movies and slates of movies.

These and other objects features and advantages of the present business system for collective financing of media with subscriber investment, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, and examples below, which are incorporated herein and form a part of the specification, illustrate some, but not the only or exclusive, examples of the business system provided by a system provider for financing films and media for investors who would be TV system operators and other broadcasters. It is intended that the embodiments and figures disclosed herein are to be considered illustrative of the invention herein, rather than limiting in any fashion.

### DESCRIPTION OF THE DRAWINGS

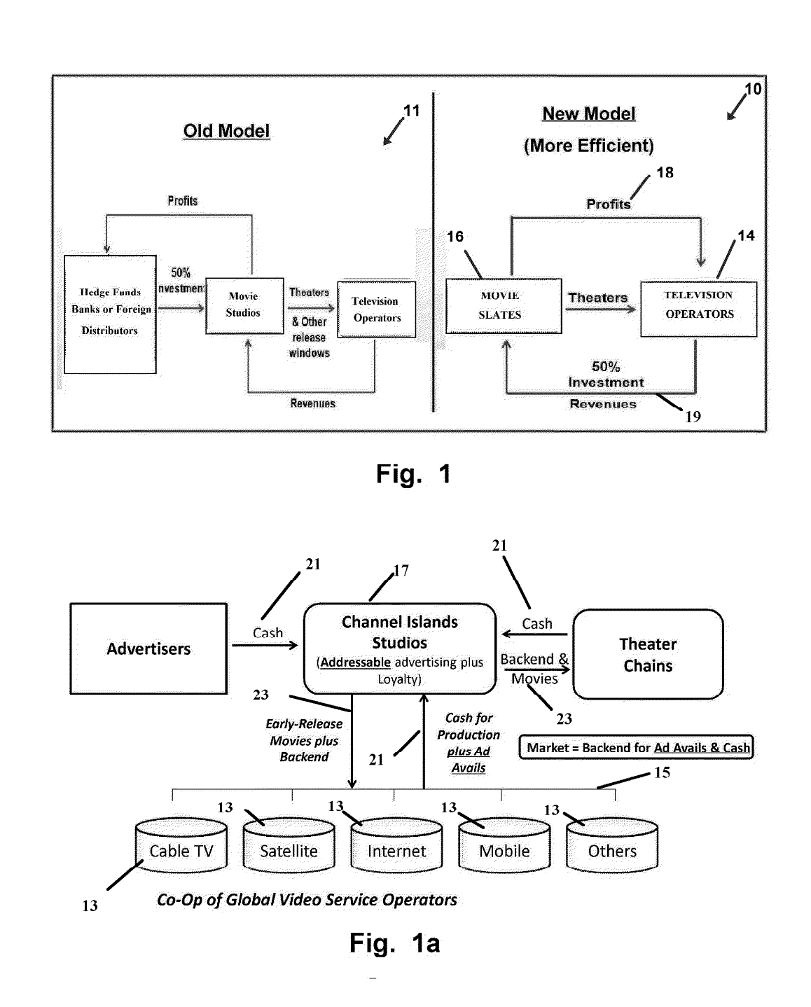

FIG. 1 depicts a mode of the cooperative financing system herein, and a depiction of the current mode of such financing films which primarily employs hedge funds and investors.

FIG. 1a depicts a current favored mode of the system herein where subscribing members provided financing and receive benefits for participation.

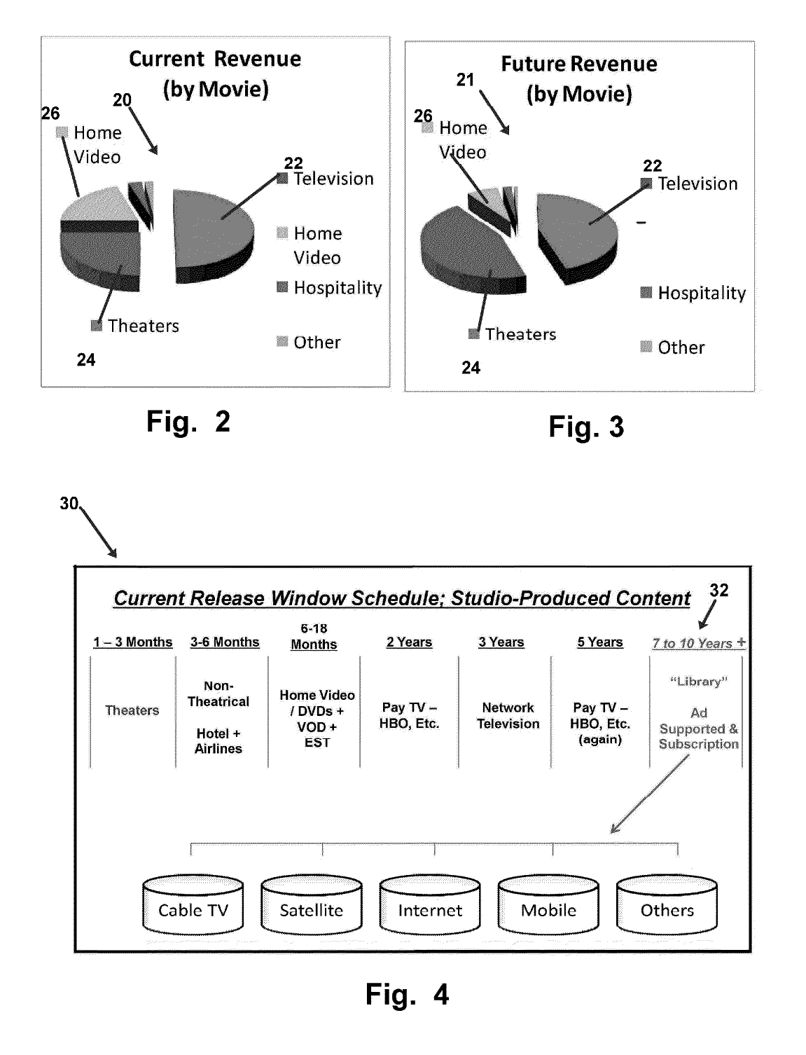

FIG. 2 depicts a typical current revenue model for motion pictures and other media productions in the current system.

FIG. 3 shows the predicted revenue model under the method of operation by the provider of the system herein.

FIG. 4 depicts the typical present day release schedule for motion pictures which places broadcasters last in line and years down the road from movie releases.

FIG. 5 shows the predicted release schedule to broadcasters where such broadcasters are participants in the system provided by the system provider to finance films.

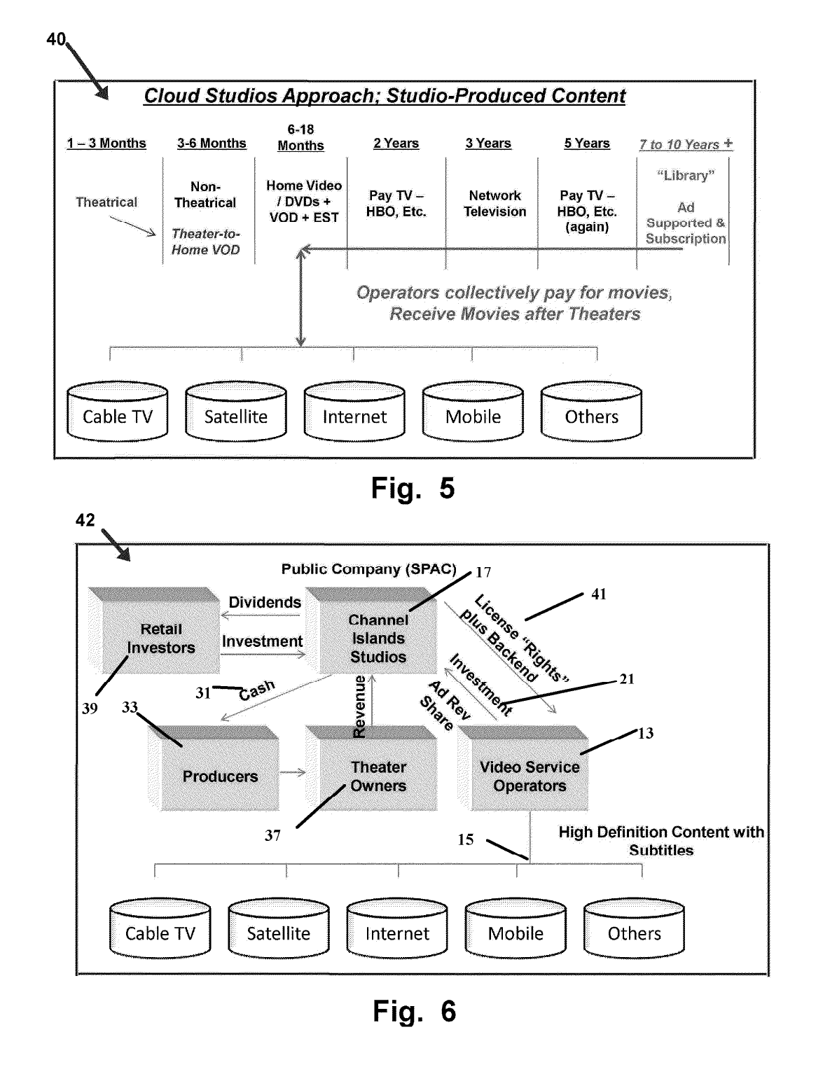

FIG. 6 depicts a flow chart of the system and method herein for production financing with the investment of members such as small and large broadcasters to combine capital with the system provider, and replace hedge funds and corporate investors.

The attached examples of how the system would work are also considered modes of the system herein.

### DETAILED DESCRIPTION OF THE INVENTION

Now referring to drawings in FIGS. 1-6, wherein similar steps and configurations are identified by like reference numerals, there is seen in FIG. 1 a mode of the system 10 herein provided by the system provider 17, and a depiction of the current mode of such media and movie financing 11 which primarily employs hedge funds and investors who are unknown to the producers and to whom the profits flow as well and funds from lending. As can be seen, there are no subscribing members 13 who benefit from membership in the present system.

As can be seen in the subscribing member system 10 for media financing herein, as depicted in FIG. 1 and FIG. 1a, subscribing members 13 which include subscribers from a group 15 of potentially benefitting subscribers, including theater chains, cable tv operators, satellite tv and media operators, internet system providers, mobile network providers such as cellular phone system providers, and other subscribing members who will wish to join the system 10 for benefit in a manner other than simply monetary return on investment as is the operative in the current system 11. The system 10 is best operated over a computer network such as the internet and allowing broadcasters to sign up as subscribers 13 using communicated video to their local video display over the network system. Sign up screens, subsequent communication of individual and slates of movies and media, the back end inducements related to each, and the monetary return for investment, can be sent to subscribing members 13 who provide the proper sign in information elicited during sign up. Funding by subscribing members 13 may also be handled over the internet, by inputting bank and other accounts from which funds may be communicated to the system provider 17 after approval by subscribers 13, or by mail if such is available.

As shown in FIG. 1 television operator 14 subscribing members such as satellite and cable system operators, such as the and broadcasters, hereinafter called broadcasters 14 who are subscribing members 13 and investors to the entity or entities operating the system 10 herein. By becoming subscribing members 13 to the system 10, through registration to the system 10 and provision of stockholder or member investment, 19 the system provider is able to amass sufficient investment capital to fund the production of movie slates 16, formerly funded by hedge funds and the like.

However, particularly preferred in the system 10 herein, revenue from investment is not the single driving factor for subscribing members 13. While revenue from investment by participating in profits 18 will serve to reduce members 13 end cost of acquiring the films and media for broadcast, subscribing members 13 are provided enhanced benefits using the media such as movies and television programs itself as a benefit. The system operator herein provides media benefits to subscribing members 13 which would not be attractive to investors such as hedge funds in the current system 11, but by being provided, enhances the profits and business of both the system 10 operator, as well as the subscribing members 13.

As can be seen in FIG. 1a, in return for investment cash 21 the system operator or studio 17 may provide to the subscribing members 13, early release 23 plus other back end access enhancement to the media or movie financed by the subscribers 13 such as advertisement avails 23a. Thus, by registering and providing investment 21 to the studio 17 provider, the subscribing members 13 may be given a choice of one or a combination of profit participation options including a cash return on investment, early release access to movies prior to or concurrent with release to theater chains, or before the movie is made available for broadcast to other non subscriber broadcasters such as cable tv systems and satellite tv systems and off air broadcasters who are not subscribing members 13 of the system 10. Such non-cash renumeration such as access to early release 23 and ad avails and other broadcaster-attractive enhancements to becoming a subscribing member 13, makes the system 10 attractive to broadcasters to join and become subscribing members 13 which insures full financing for the studio 17 system operator.

The enhancement provided by becoming subscribing members can be seen in FIG. 2 which depicts a typical current revenue model 20 for motion pictures and other media productions and their release. As can be seen, because of the broadcasters who are subscribing members 13 in the system 10, currently trail in the release of films and other media for broadcast to the public, the broadcaster revenue 22 suffers. This is because viewers conventionally flock to theaters 24 and do not view the re-broadcast of films and media in high percentages. Thus in the current mode of the system financing movies and media, the current larger share of revenue from a showing of movies and media to the public, goes to the theaters 24 and the sale of DVD in home media 26 both of which occur well before broadcasters who would be subscribers 13 in the system 10 herein, ever have the chance to provide viewings of the movie or media to their subscribing audience.

FIG. 3 shows the predicted revenue model 21 under the method of operation of the system 10 herein, where subscribing members 13 who are broadcasters and communication network providers are attracted to the system by the broadcaster-enhanced return on investment. Employing the system 10 herein, subscribing members 13 will provide funding for films and media generated by the system provider 17. As shown, the system 10 in addition to providing enhanced access to broadcasting rights to the produced media in which they invest, the system will provide the subscribing members 13 such as TV system operators and broadcasters 14 with extra revenue sources and enhanced revenue from a new structure herein which provides members 13 enhanced or first broadcasting rights to films and other broadcast media. As can be discerned, in addition to return on provided investment 21, the subscribing members 13 have enhanced broadcaster revenue 22 due to the change in the release schedule providing subscriber members 13 initial or early rights to broadcast the films and media generated by the system provider 17 which will generate larger audiences which in the broadcast industry, requires increased payments by advertisers. Thus, the provision of enhanced broadcast access rights, ad avails, and other broadcaster-attractive enhancements for subscribing members 13, will enhance funding 21 to the system operator 17 from broadcasters who are subscribing members 13.

FIG. 4 depicts the typical present day movie and media release schedule 30 for motion pictures. As can be seen, broadcasters 32 who in the system herein are subscribing members 13, under the current system are the last in line to obtain broadcast rights which places their ability to broadcast to their subscribing viewers, years subsequent to the original release of the film through theater chains. Thus, there is no provision of enhanced return that would be attractive to subscribing members 13 who are broadcasters in the current system and severely impaired revenue from broadcasting of movies and media which is years behind theater release.

FIG. 5 shows the predicted release schedule 40 of the system 10 herein, to subscribing members 13 who are broadcasters 32. As can be seen, in this studio produced content system, where subscribing members 13 join by signing up for the system and providing financing 21 to the studio or system operator 17, a significant enhancement is provided for broadcasters 32 to become subscribing members 13 and investors in the movies and media produced in the system 10 herein to finance films. As shown, the broadcasters 32 who become subscribing members 13 to the system 10 by signing up and providing investment 21, will be given broadcast rights directly after theaters and prior to DVD release for retail sale which conventionally severely impairs viewer interest in watching the movie or film on a broadcaster's 32 system. The enhance access to subscribing member 13 broadcasters thus will allow for a higher viewership audience which in the broadcast industry, relates directly to the amount of advertising revenue derived from time slots on a broadcaster's network or system. Thus subscribing members 13 who are from a group of broadcasters including Cable TV system operators, Satellite broadcast system operators, Internet system operators and streaming media providers, mobile communication systems such as cellular providers, and other broadcasters who must compete with movie theaters for movie broadcast rights, will be attracted to become subscribing members 13 to the system 10 due to the significant benefits above and beyond investment return.

FIG. 6 depicts a flow chart 42 of the system 10 and method herein for the broadcasters or video service operators, who sign on as subscribing members 13 to provided production financing using a cooperative of small and large broadcaster members, to combine capital and replace hedge funds and corporate investors in the conventional system.

In the system 10 shown in the flow chart 42, the investment 21 from broadcasters or video service operators who sign on as subscribing members 13 is communicated to the system operator 17.

The system operator 17 provides funding 31 to movie producers 33 who actually make the movies and media which is provided to theaters 37 for viewing by the public. While other investors such as retail investors 39 or theaters 37 may invest and provide funding 21 to the system operator 17, it is the broadcasters or video service operators who are subscribing members 13 who are provided enhanced access 41 to broadcast the produced movie or media, ad slots, as well as a share of the revenue on movies in which they provide funding 21 as noted above.

The broadcasters and video service operators who are subscribing members 13 optionally may be allowed to view upcoming movie projects of the system provider 17, and provide their funding 21 specifically to provide funding 31 for a specific movie or media project. In doing so, the subscribing member 13 may be provided enhanced broadcast rights to the specific movie financed, while other non investing members 13 might not, or might be given slightly less enhanced broadcast and back end rights. This optional mode of the system 10 will thus allow subscribing members 13 to invest in movies and media which they decide may be particularly attractive for their viewers and thus will provide the members 13 who are broadcasters a manner to gain enhanced rights specifically related to a chosen movie or project, and enhance participation by the members 13 to provide funding 21 over time.

As a system, broadcasters would subscribe to the system 10 and become subscribing members 13 through online information input, or other means to communicate their individual identifying information. Once a subscribing member 13 the broadcasters can be given ongoing updates on upcoming planned movie projects which the system provider 17 will be working upon with producers 33. Subscribing members 13 may invest money for funding 21 of individual, or slates including a plurality of movies or media projects in the slate.

Thereafter, subscribing members 13 who have invested to provide funding 21 to the system provider 17 for an individual movie will participate in the profits and revenues of that movie or media project, and, will be given enhanced broadcast rights to the individual movie or media project which will allow the subscribing member to broadcast the movie or media prior to DVD release, and prior to other non investing subscribing members 13 who may be providing funding 21 for other individual movies or media, or other slates of movies or medial projects.

In another mode of the system 10 as noted, slates including a plurality of movies or media projects will be communicated to the subscribing members 13 to allow them to provide funding 21 to the system operator 17 to finance the entire slate or plurality of movies or media projects. Subscribing members 13 who fund a slate, will be given enhanced broadcast rights and back end enhancements such as advertisement avails, which may not be provided to non investing subscribing members, or which may be slightly less enhanced when provided to non investing members 13. In all modes of the system 10 however, enhanced broadcast rights and back end rights are provided to subscribing members 13 who provide the funding 21 to the system 10, which are particularly attractive to broadcasters and video service operators who are subscribing members 13 thereby enhancing and insuring sufficient funding 21 for projects.

As noted above, while the present invention has been described herein with reference to particular embodiments thereof and steps in the method of production, a latitude of modifications, various changes and substitutions are intended in the foregoing disclosures, it will be appreciated that in some instance some features or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A system for financing of film and media productions comprising:
allowing broadcasters to communicate with a server having software configured to allow for input of information concerning an identity of a communicating broadcaster;
storing said information concerning identity and associating said information with a subscribing member identity to the system operated by the system operator, for each respective broadcaster;
communicating upcoming movie and media productions to be financed to respective said subscribing members;
communicating non monetary enhancements to a return on investment provided to investing subscribing members;
allowing respective subscribing members communicate a monetary investment in said upcoming movie and media productions;
communicating a monetary return to each respective subscribing member in a respective movie or media production, from revenues from said respective movie or media productions; and
communicating said non-monetary enhancement to respective said subscribing members who have provided said monetary investment in said respective movie or media production.

2. The system of claim 1, additionally including:
as said non-monetary enhancement, providing broadcast rights to said respective said movie or media production, to respective subscribing members who provided a respective said monetary investment in said respective movie or media production, at an earlier date than to subscribing members who have not provided a said monetary investment in said respective movie or media production.

3. The system of claim 1 additionally including:
allowing said subscribing user to choose a single said movie for which said subscribing user provides said monetary investment.

4. The system of claim 1 additionally including:
allowing said subscribing user to choose a media slate for which said subscribing user provides said monetary investment, said media slate including a plurality of individual movies or media productions for which said monetary investment will provide funding.

5. The system of claim 2 additionally including:
allowing said subscribing user to choose a single said movie for which said subscribing user provides said monetary investment.

6. The system of claim 2 additionally including:
allowing said subscribing user to choose a media slate for which said subscribing user provides said monetary investment, said media slate including a plurality of individual movies or media productions for which said monetary investment will provide funding.
